(19) United States
(12) Patent Application Publication
(10) Pub. No.: US 2007/0021615 A1
(43) Pub. Date: Jan. 25, 2007

(54) Imidazolium salts that can be immobilized

(76) Inventors: Katrin Köhler, Göttingen (DE); Kerstin Weigl, Bad Salzungen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/567,858

(22) PCT Filed: Jul. 14, 2004
(86) PCT No.: PCT/EP04/07778

§ 371 Date: Feb. 10, 2006

(30) Foreign Application Priority Data
Aug. 11, 2003 (DE) 103 37 120.6

(51) Int. Cl. C07F 7/02

(52) U.S. Cl. 548/110

(57) ABSTRACT

The invention relates to novel immobilisable imidazolium salts of the general formulae (I) and (II) 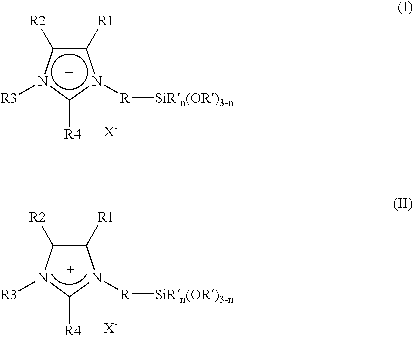
which contain a group R carrying SiR′ₙ(OR′)₃₋ₙ on one of the two nitrogen atoms and a sterically demanding cyclic hydrocarbon radical on the other of the two nitrogen atoms of the heterocyclic ring. The invention furthermore relates to the use of the compounds of the general formulae (I) and (II) as starting materials for immobilisable catalyst ligands, catalyst precursors and catalysts, and to the use as solvents in organic, organometallic and transition metal-catalysed synthesis and as catalysts in organic synthesis.

The invention relates to novel immobilisable imidazolium salts of the general formulae (I) and (II) 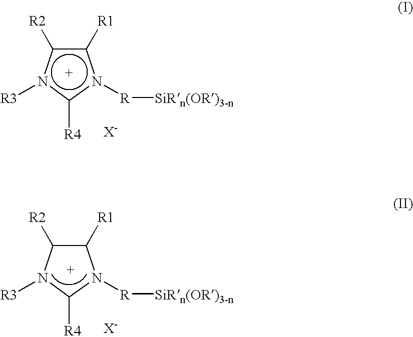
which contain a group R carrying SiR′ₙ(OR′)₃₋ₙ on one of the two nitrogen atoms and a sterically demanding hydrocarbon radical R3 on the other of the two nitrogen atoms of the heterocyclic ring. The invention furthermore relates to the use of the compounds in organic synthesis and as ligand precursors for the preparation of immobilisable and immobilised catalysts.

### 1. PRIOR ART AND OBJECT OF THE INVENTION

Examples of sterically undemanding imidazolium and 4,5-dihydroimidazolium salts containing trialkoxysilyl groups are described in WO 01/32308, WO 02/098560 and in J. Am. Chem. Soc. 2002, 124, 12932; Topics in Catalysis 2001, 14, 139; Journal of Catalysis 2000, 196, 86; J. Mol. Cat. A: Chem. 2002, 184, 31. These are compounds of type A and B.

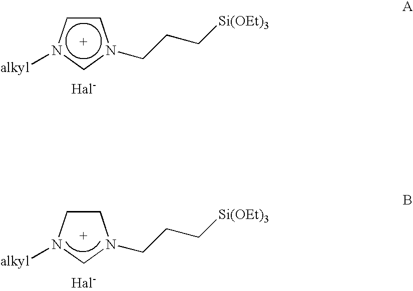

Compounds of type A and B were either immobilised directly on inorganic oxides or converted into the corresponding surface-modified silica via a solgel method. These compounds are unsuitable with respect to use of such systems as precursors for immobilisable NHC (N-heterocyclic carbene) ligands. This is due to the sterically undemanding alkyl groups on the nitrogen atoms of the heterocyclic ring, which result in thermal instability at room temperature. Furthermore, some representatives of these compounds tend towards dimerisation reactions. These disadvantages can be overcome, as described in WO 98/27064; WO 00/15339; J. Am. Chem. Soc. 1992, 114, 5530; Chem. Eur. J. 1996, 2, 1627; Tetrahedron 1999, 55, 14523, by introducing sterically demanding hydrocarbon radicals instead of the alkyl groups on the two nitrogen atoms in A and B, as shown in C and D.

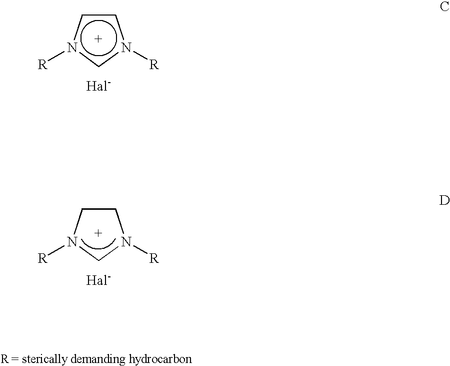

Hydrocarbon radicals of this type can be substituted aromatic radicals, such as, for example, mesityl radicals, but also adamantyl, cyclohexyl, etc. However, compounds of types C and D cannot be immobilised covalently on inorganic oxides since they do not contain suitable functional groups capable of coupling. However, immobilisation is essential with respect to use of these imidazolium and 4,5-dihydroimidazolium salts as catalysts or as precursors for NHC ligands, which are employed in an ever more versatile manner in homogeneous transition-metal catalysis. Immobilisation facilitates simple separation of the transition-metal catalysts from the resultant products. In practical homogeneous catalysis, this still represents a major problem. This problem can be solved with the provision of immobilisable ligands.

The object of the present invention was therefore to provide immobilisable imidazolium and 4,5-dihydroimidazolium salts which can be employed as catalysts or as precursors for NHC ligands and can be prepared in a simple and inexpensive process. A further object of the invention was to provide corresponding imidazolium and 4,5-dihydroimidazolium salts of high thermal stability which can be covalently bonded to inorganic oxides as support materials and are subsequently available in sufficiently large amount on the oxide surface for application reactions. To this end, they should be strongly anchored to the surface and should not be re-detached from the oxide surface by the addition of solvents.

### 2. DESCRIPTION OF THE INVENTION

The object of the present invention is achieved by the preparation of sterically demanding, immobilisable imidazolium and 4,5-dihydroimidazolium salts which carry an SiR′ₙ(OR′)₃₋ₙ group on one of the two nitrogen atoms and have a sterically demanding cyclic hydrocarbon radical or a heterocyclic radical on the other nitrogen atom of the heterocyclic ring.

In particular, the object is achieved by compounds of the general formulae (I) and (II) 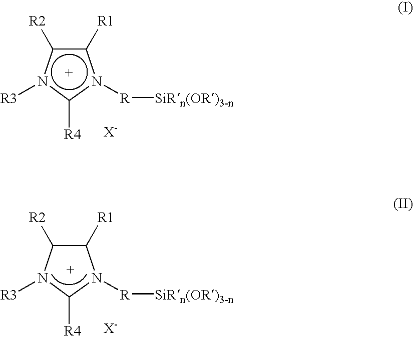
in which
R is A, Ar, A—Ar, A—Ar—A, Het, AHet or AHetA having a total of not more than 30 carbon atoms, where
A is a straight-chain, branched, saturated or mono- or polyunsaturated C₁-C₂₀-alkyl radical, cycloalkyl or cycloalkyl bonded via one or two alkyl group(s) having a total of 4-30 carbon atoms, where one CH₂ or CH group both in the alkyl radical and in the cycloalkyl radical may be replaced by N, NH, NA, O and/or S,
Ar is mono- or polysubstituted or unsubstituted phenyl, naphthyl, anthryl or phenanthryl having a total of not more than 20 carbon atoms, where substituents may be A, Hal, OA, CO—AOH, COOH, COOA, COA, OH, CN, CONHA, NO₂, ═NH or ═O,
Het is a monocyclic or bicyclic, saturated, unsaturated or aromatic heterocyclic radical having from 1 to 4 N, O and/or S atoms, which may be unsubstituted or mono-, di- or trisubstituted by Hal and/or A, OA, CO—AOH, COOH, COOA, COA, OH, CN, CONHA, NO₂, ═NH or ═O, where
Hal is F, Cl, Br or I,
R′, independently of the position in the molecule, is A or Ar having 1-12 carbon atoms,
R3 is A, Ar, AAr, AArA, Het, AHet or AHetA having 6-18 carbon atoms, in which the radical A which is not bonded to Ar or Het is cycloalkyl which is unsubstituted or substituted by one or more groups Z, and Ar is an aromatic hydrocarbon which is unsubstituted or mono- or polysubstituted by a group Z, and Het is a saturated, unsaturated or aromatic heterocyclic radical, which may be mono- or polysubstituted by a group Z, and
R1, R2 and R4, independently of one another, are H, Cl, Br or a straight-chain, branched, saturated or mono- or polyunsaturated C₁-C₇-alkyl radical, where one or more H in the alkyl radical may be replaced by Z,
X is a singly charged organic or inorganic salt-forming anion,
Z is A or Ar, where H atoms in A or Ar may be substituted, independently of the position in R1, R2, R3 and R4, by functional groups containing N, P or O atoms, and
n. is 0, 1 or 2.

In particular, the object of the present invention is achieved by the provision of compounds as characterised by sub-claims 2 to 5, and very particularly by the compounds
1-mesityl-3-[3-(triethoxysilyl)propyl]imidazolium chloride
1-mesityl-3-[3-(triethoxysilyl)propyl]imidazolium bromide
1-mesityl-3-[3-(triethoxysilyl)propyl]imidazolium triflate
1-mesityl-3-[3-(triethoxysilyl)propyl]imidazolium tetrafluoroborate
1-mesityl-3-[3-(triethoxysilyl)propyl]imidazolium hexafluorophosphate
1-mesityl-3-[3-(trimethoxysilyl)propyl]imidazolium chloride
1-mesityl-3-[3-(trimethoxysilyl)propyl]imidazolium bromide
1-mesityl-3-[3-(trimethoxysilyl)propyl]imidazolium triflate
1-mesityl-3-[3-(trimethoxysilyl)propyl]imidazolium tetrafluoroborate
1-mesityl-3-[3-(trimethoxysilyl)propyl]imidazolium hexafluorophosphate
1-mesityl-3-[4-(trimethoxysilyl)benzyl]imidazolium chloride
1-mesityl-3-[4-(trimethoxysilyl)benzyl]imidazolium bromide
1-mesityl-3-[4-(trimethoxysilyl)benzyl]imidazolium triflate
1-mesityl-3-[4-(trimethoxysilyl)benzyl]imidazolium tetrafluoroborate
1-mesityl-3-[4-(trimethoxysilyl)benzyl]imidazolium hexafluorophosphate
1-mesityl-3-[4-(triethoxysilyl)benzyl]imidazolium chloride
1-mesityl-3-[4-(triethoxysilyl)benzyl]imidazolium bromide
1-mesityl-3-[4-(triethoxysilyl)benzyl]imidazolium triflate
1-mesityl-3-[4-(triethoxysilyl)benzyl]imidazolium tetrafluoroborate
1-mesityl-3-[4-(triethoxysilyl)benzyl]imidazolium hexafluorophosphate
1-mesityl-3-[3-(triethoxysilyl)propyl]imidazolium chloride
1-mesityl-3-[3-(triethoxysilyl)propyl]imidazolium bromide
1-mesityl-3-[3-(triethoxysilyl)propyl]imidazolium triflate
1-mesityl-3-[3-(triethoxysilyl)propyl]imidazolium tetrafluoroborate
1-mesityl-3-[3-(triethoxysilyl)propyl]imidazolium hexafluorophosphate
1-cyclohexyl-3-[3-(trimethoxysilyl)propyl]imidazolium chloride
1-cyclohexyl-3-[3-(trimethoxysilyl)propyl]imidazolium bromide
1-cyclohexyl-3-[3-(trimethoxysilyl)propyl]imidazolium triflate
1-cyclohexyl-3-[3-(trimethoxysilyl)propyl]imidazolium tetrafluoroborate
1-cyclohexyl-3-[3-(trimethoxysilyl)propyl]imidazolium hexafluorophosphate
1-cyclohexyl-3-[4-(trimethoxysilyl)benzyl]imidazolium chloride
1-cyclohexyl-3-[4-(trimethoxysilyl)benzyl]imidazolium bromide
1-cyclohexyl-3-[4-(trimethoxysilyl)benzyl]imidazolium triflate
1-cyclohexyl-3-[4-(trimethoxysilyl)benzyl]imidazolium tetrafluoroborate
1-cyclohexyl-3-[4-(trimethoxysilyl)benzyl]imidazolium hexafluorophosphate
1-cyclohexyl-3-[4-(triethoxysilyl)benzyl]imidazolium chloride
1-cyclohexyl-3-[4-(triethoxysilyl)benzyl]imidazolium bromide
1-cyclohexyl-3-[4-(triethoxysilyl)benzyl]imidazolium triflate
1-cyclohexyl-3-[4-(triethoxysilyl)benzyl]imidazolium tetrafluoroborate
1-cyclohexyl-3-[4-(triethoxysilyl)benzyl]imidazolium hexafluorophosphate
1-mesityl-3-[3-(triethoxysilyl)propyl]-4,5-dihydroimidazolium chloride
1-mesityl-3-[3-(triethoxysilyl)propyl]-4,5-dihydroimidazolium bromide
1-mesityl-3-[3-(triethoxysilyl)propyl]-4,5-dihydroimidazolium triflate
1-mesityl-3-[3-(triethoxysilyl )propyl]-4,5-dihydroimidazolium tetrafluoroborate
1-mesityl-3-[3-(triethoxysilyl)propyl]-4,5-dihydroimidazolium hexafluorophosphate
1-mesityl-3-[3-(trimethoxysilyl)propyl]-4,5-dihydroimidazolium chloride
1-mesityl-3-[3-(trimethoxysilyl)propyl]-4,5-dihydroimidazolium bromide
1-mesityl-3-[3-(trimethoxysilyl)propyl]-4,5-dihydroimidazolium triflate
1-mesityl-3-[3-(trimethoxysilyl)propyl]-4,5-dihydroimidazolium tetrafluoroborate
1-mesityl-3-[3-(trimethoxysilyl)propyl]-4,5-dihydroimidazolium hexafluorophosphate
1-mesityl-3-[4-(trimethoxysilyl)benzyl]-4,5-dihydroimidazolium chloride
1-mesityl-3-[4-(trimethoxysilyl)benzyl]-4,5-dihydroimidazolium bromide
1-mesityl-3-[4-(trimethoxysilyl)benzyl]-4,5-dihydroimidazolium triflate
1-mesityl-3-[4-(trimethoxysilyl)benzyl]-4,5-dihydroimidazolium tetrafluoroborate
1-mesityl-3-[4-(trimethoxysilyl)benzyl]-4,5-dihydroimidazolium hexafluorophosphate
1-mesityl-3-[4-(triethoxysilyl)benzyl]-4,5-dihydroimidazolium chloride
1-mesityl-3-[4-(triethoxysilyl)benzyl]-4,5-dihydroimidazolium bromide
1-mesityl-3-[4-(triethoxysilyl)benzyl]-4,5-dihydroimidazolium triflate
1-mesityl-3-[4-(triethoxysilyl)benzyl]-4,5-dihydroimidazolium tetrafluoroborate
1-mesityl-3-[4-(triethoxysilyl)benzyl]-4,5-dihydroimidazolium hexafluorophosphate
1-mesityl-3-[3-(triethoxysilyl)propyl]-4,5-dihydroimidazolium chloride
1-mesityl-3-[3-(triethoxysilyl)propyl]-4,5-dihydroimidazolium bromide
1-mesityl-3-[3-(triethoxysilyl)propyl]-4,5-dihydroimidazolium triflate
1-mesityl-3-[3-(triethoxysilyl)propyl]-4,5-dihydroimidazolium tetrafluoroborate
1-mesityl-3-[3-(triethoxysilyl)propyl]-4,5-dihydroimidazolium hexafluorophosphate
1-cyclohexyl-3-[3-(trimethoxysilyl)propyl]-4,5-dihydroimidazolium chloride
1-cyclohexyl-3-[3-(trimethoxysilyl)propyl]-4,5-dihydroimidazolium bromide
1-cyclohexyl-3-[3-(trimethoxysilyl)propyl]-4,5-dihydroimidazolium triflate
1-cyclohexyl-3-[3-(trimethoxysilyl)propyl]-4,5-dihydroimidazolium tetrafluoroborate
1-cyclohexyl-3-[3-(trimethoxysilyl)propyl]-4,5-dihydroimidazolium hexafluorophosphate
1-cyclohexyl-3-[4-(trimethoxysilyl)benzyl]-4,5-dihydroimidazolium chloride
1-cyclohexyl-3-[4-(trimethoxysilyl)benzyl]-4,5-dihydroimidazolium bromide
1-cyclohexyl-3-[4-(trimethoxysilyl)benzyl]-4,5-dihydroimidazolium triflate
1-cyclohexyl-3-[4-(trimethoxysilyl)benzyl]-4,5-dihydroimidazolium tetrafluoroborate
1-cyclohexyl-3-[4-(trimethoxysilyl)benzyl]-4,5-dihydroimidazolium hexafluorophosphate
1-cyclohexyl-3-[4-(triethoxysilyl)benzyl]-4,5-dihydroimidazolium chloride
1-cyclohexyl-3-[4-(triethoxysilyl)benzyl]-4, 5-dihydroimidazolium bromide
1-cyclohexyl-3-[4-(triethoxysilyl)benzyl]-4,5-dihydroimidazolium triflate
1-cyclohexyl-3-[4-(triethoxysilyl)benzyl]-4,5-dihydroimidazolium tetrafluoroborate
1-cyclohexyl-3-[4-(triethoxysilyl)benzyl]-4,5-dihydroimidazolium hexafluorophosphate as compounds in accordance with the general formula (I).

The present invention also relates to a process for the preparation of the compounds of the general formulae (I) and (II) from compounds of the general formulae (III) and (IV) known per se 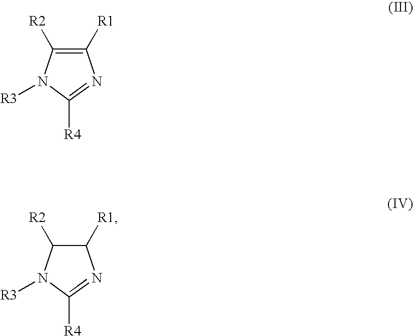
in which R1, R2, R3 and R4 are as defined above, by reaction with alkoxy-silanes of the general formula V
Hal—R—SiR′ₙ(OR′)₃₋ₙ, (V)
in which Hal is Cl, Br or I, and R and R′ are-as defined above.

The present invention furthermore relates to the use of the prepared compounds of the general formulae (I) and (II) as starting′material for the preparation of immobilised imidazolium and 4,5-dihydroimidazolium salts, immobilisable and immobilised NHC catalyst ligands, immobilisable and immobilised catalyst precursors, immobilisable and immobilised catalysts and to the use of the compounds as catalysts in organic or organometallic and transition metal-catalysed reactions, as solvents in organic or organometallic and transition metal-catalysed reactions, such as, for example, hydrogenations, oxidations, hydroformylations, coupling reactions or oligomerisations, to the use as ionic fluid and as solvent for 2-phase reactions, or to the use for the preparation of immobilised ionic fluids, immobilised solvents for, for example, hydrogenations, oxidations, hydroformylations, coupling reactions or oligomerisations, as immobilised ligands or immobilised catalyst precursors, or as separation media for the separation of substance mixtures and as medium for the purification of reaction products (scavenger function).

### 3. DETAILED DESCRIPTION OF THE INVENTION

Compounds of the general formulae (I) and (II) according to the invention are imidazolium and 4,5-dihydroimidazolium salts. (I) comprises a 1,3-disubstituted imidazolium cation with a singly charged anion, and (II) comprises a 1,3-disubstituted 4,5-dihydroimidazolium cation likewise with a singly charged anion.

A cyclic radical (R3) and a silyl group R—SiR′ₙ(OR′)ₙ₋₃ immobilisable on inorganic oxides are bonded to the two nitrogen atoms of the heterocyclic radical, the Si(OR′)₃₋ₙ unit being capable of subsequent reaction, in particular with a metal oxide having active OH groups on the surface.

R′ in the SiR′ₙ(OR′)₃₋ₙ unit is a hydrocarbon radical, where n can be 0, 1 or 2, preferably 0 or 1 and very preferably 0. This hydrocarbon radical R′ can adopt different meanings independently of the position in-the molecule and can be straight-chain, unbranched (linear), branched, saturated or mono- or polyunsaturated, cyclic (A) or aromatic (Ar), and optionally mono- or polysubstituted.

A and Ar can adopt all the meanings given below.

R′ is preferably a straight-chain, unbranched (linear), branched, saturated or mono- or polyunsaturated or cyclic saturated or mono- or polyunsaturated alkyl radical having 1-12 carbon atoms. R′ is particularly preferably a straight-chain or branched saturated alkyl radical having 1-7 carbon atoms, i.e. a sub-group of the alkyl group A, which is defined in greater detail below.

R′ can adopt the meanings methyl, ethyl, propyl, i-propyl, butyl, sec-butyl, tert-butyl, pentyl, 1-, 2- or 3-methylbutyl(—C₅H₁₀—), 1,1-, 1,2- or 2,2-dimethylpropyl(—C₅H₁₀—), 1-ethyl-propyl (—C₅H₁₀—), hexyl(—C₆H₁₂—), 1-, 2-, 3- or 4-methylpentyl(—C₆H₁₂—), 1,1-, 1,2-, 1,3-, 2,2-, 2,3- or 3,3-dimethylbutyl(—C₆H₁₂—), 1- or 2-ethylbutyl(—C₆H₁₂—), 1-ethyl-1-methylpropyl(—C₆H₁₂—), 1-ethyl-2-methylpropyl(—C₆H₁₂—), 1,1,2- or 1,2,2-trimethylpropyl(—C₆H₁₂—), heptyl or octyl.

In SiR′ₙ(OR′)ₙ₋₃, R′ can, however, alternatively be
alkenyl vinyl, propenyl, 1,2-propadienyl, butenyl, butadienyl, pentenyl, 1,2-, 1,4- or1,3-pentadienyl, 2,3-dimethyl-2-butenyl, hexenyl, 1,5-hexadienyl, 2-methyl-1-,3-butadienyl, 2,3-dimethyl-1,3-butadienyl or isopentenyl,
cycloalkenyl cyclopropenyl, cyclobutenyl, cyclopentenyl, cyclopentadienyl or methylcyclopentadienyl and
alkynyl ethynyl, 1,2-propynyl, 2-butynyl, 1,3-butadiynyl, pentynyl or hexynyl.

The larger the number of alkoxy radicals in the SiR′ₙ(OR′)₃₋ₙ group and thus the smaller is n, the larger can be the number of covalent bonds between the metal oxide and the compounds of the general formulae (I) and (II) after immobilisation.

The SiR′ₙ(OR′)₃₋ₙ group is bonded to the nitrogen atom of the heterocyclic radical via a hydrocarbon radical R.

The hydrocarbon radical R is preferably a radical having 1-30 carbon atoms. This hydrocarbon radical may be straight-chain, unbranched (linear), branched, saturated or mono-, or polyunsaturated, cyclic (A) or aromatic (Ar), heterocyclic or heteroaromatic (Het) and optionally mono- or polysubstituted.

The hydrocarbon radical R can be an A, Ar, A—Ar, A—Ar—A, Het, A—Het or A—Het radical, where each of the groups A, Ar and Het can adopt the meanings given below.
A is straight-chain, unbranched (linear), branched, saturated or mono- or polyunsaturated or cyclic alkyl radical A having 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 carbon atoms, preferably having 1, 2, 3, 4, 5, 6, 7, 8, 9, 10, 11 or 12 carbon atoms.

Alkylene has the same meanings as indicated for A, with the proviso that a further bond exists from the alkyl to the closest bonding neighbour.
A can be, for example, an alkylene group selected from the group consisting of methylene(—CH₂—), ethylene(—C₂H₄—), propylene(—C₃H₆—), isopropylene(—C₃H₆—), butylene(—C₄H₈—), isobutylene(—C₄H₈—), sec-butylene (—C₄H₈—) and tert-butylene(—C₄H₈—), furthermore also pentylene (—C₅H₁₀—), 1-, 2- or 3-methylbutylene(—C₅H₁₀—), 1,1-, 1,2- or 2,2-dimethyl-propylene (—C₅H₁₀—), 1-ethylpropylene(—C₅H₁₀—), hexylene(—C₆H₁₂—), 1-, 2-, 3- or 4-methylpentylene(—C₆H₁₂—), 1,1-, 1,2-, 1,3-, 2,2-, 2,3- or 3,3-dimethylbutylene(—C₆H₁₂—), 1- or 2-ethylbutylene(—C₆H₁₂—), 1-ethyl-1-methylpropylene(—C₆H₁₂—), 1-ethyl-2-methylpropylene(—C₆H₁₂—), 1,1,2- or 1,2,2-trimethylpropylene(—C₆H₁₂—), heptylene, octylene, nonylene, decylene, undecylene or dodecylene.
A can also be a cycloalkylene group having 3-30 carbon atoms, preferably C₃-C₉-cycloalkylene. Cycloalkyl here can be saturated or unsaturated and optionally bonded via one or two alkyl groups in the molecule to the imidazole nitrogen and the SiR′ₙ(OR′)ₙ₋₃ group. One or more H atom(s) may also be replaced by other substituents in the cycloalkylene group. Cycloalkyl is preferably cyclopropyl, cyclobutyl, cyclopentyl, cyclohexyl, methylcyclopentyl, cycloheptyl, methylcyclohexyl, cyclooctyl, 3-menthyl or camphor-10-yl(bicyclic terpene), decalin or bicycloheptane, where these groups can be bonded via one or two alkyl groups in the molecule to the imidazole nitrogen and the SiR′ₙ(OR′)ₙ₋₃ group.

In this case, cycloalkyl is preferably 1,2-cyclopropyl, 1,2- or 1,3-cyclobutyl, 1,2- or 1,3-cyclopentyl, or 1,2-, 1,3- or 1,4-cyclohexyl, furthermore 1,2-, 1,3- or 1,4-cycloheptyl. However, the said groups can also, as R3, be bonded in substituted or unsubstituted form to the second imidazole nitrogen.

A can also be an unsaturated alkenyl or alkynyl group having 2-20 carbon atoms, which is bonded both to the imidazole nitrogen and to the SiR′ₙ(OR′)ₙ₋₃ group.

Alkenyl groups can be straight-chain, branched or cyclic C₂-C₃₀-alkenyl groups, preferably straight-chain, branched or cyclic C₂-C₉-alkenyl groups, particularly preferably straight-chain or branched C₂-C₆-alkenyl groups.

Cycloalkenyl groups can be straight-chain or branched C₃-C₃₀-cycloalkenyl groups, preferably C₃-C₉-cycloalkenyl groups, particularly preferably C₃-C₆-cycloalkenyl groups.

Alkynyl groups can be straight-chain or branched C₂-C₃₀-alkynyl groups, preferably straight-chain or branched C₂-C₉-alkynyl groups.

If alkenyl, cycloalkenyl or alkynyl is part of the hydrocarbon radical R, it of course has the same meanings, with the proviso that a further bond exists from the alkenyl or from the alkynyl to the closest bonding neighbour in the molecule.

Ar is a mono- or polycyclic aromatic hydrocarbon radical having 6-30 carbon atoms, which may be mono- or polysubstituted or unsubstituted.

Aryl groups can preferably be C₆-C₁₀-aryl groups, preferably phenyl or naphthyl. Alkylaryl groups can be C₇-C₁₈-alkylaryl groups, preferably tolyl or mesityl.
Ar is preferably substituted or unsubstituted phenyl, naphthyl, anthryl or phenanthryl, each of which may be mono-, di- or trisubstituted by A, OA, CO—AOH, COOH, COOA, fluorine, chlorine, bromine, iodine, hydroxyl, methoxy, ethoxy, propoxy, butoxy, pentyloxy, hexyloxy, nitro, cyano, formyl, acetyl, propionyl, trifluoromethyl, amino, methylamino, ethylamino, dimethylamino, diethylamino, benzyloxy, sulfonamido, methylthio, methylsulfinyl, methylsulfonyl, methylsulfonamido, ethylsulfonamido, propylsulfonamido, butylsulfonamido, dimethylsulfonamido, phenylsulfonamido, carboxyl, methoxycarbonyl, ethoxycarbonyl or aminocarbonyl,
   where Ar has not more than 20 carbon atoms if it is substituted by A and/or bonded to A.
Ar is preferably unsubstituted or mono- or polysubstituted phenyl, and specifically preferably phenyl, o-, m- or p-tolyl, o-, m- or p-ethylphenyl, o-, m- or p-propylphenyl, o-, m- or p-isopropylphenyl, o-, m- or p-tert-butylphenyl, o-, m- or p-cyanophenyl, o-, m- or p-methoxyphenyl, o-, m- or p-ethoxyphenyl, o-, m- or p-fluorophenyl, o-, m- or p-bromophenyl, o-, m- or p-chlorophenyl, o-, m- or p-methylthiophenyl, o-, m- or p-methylsulfinylphenyl, o-, m- or p-methylsulfonylphenyl, o-, m- or p-aminophenyl, o-, m- or p-methylaminophenyl, o-, m- or p-dimethyl-aminophenyl, o-, m- or p-nitrophenyl, 2,3-, 2,4-, 2,5-, 2,6-, 3,4- or 3,5-difluorophenyl, 2,3-, 2,4-, 2,5-, 2,6-, 3,4- or 3,5-dichlorophenyl, 2,3-, 2,4-, 2,5-, 2,6-, 3,4- or 3,5-dibromophenyl, 2-chloro-3-methyl-, 2-chloro-4-methyl-, 2-chloro-5-methyl-, 2-chloro-6-methyl-, 2-methyl-3-chloro-, 2-methyl-4-chloro-, 2-methyl-5-chloro-, 2-methyl-6-chloro-, 3-chloro-4-methyl-, 3-chloro-5-methyl- or 3-methyl-4-chlorophenyl, 2-bromo-3-methyl-, 2-bromo-4-methyl-, 2-bromo-5-methyl-, 2-bromo-6-methyl-, 2-methyl-3-bromo-, 2-methyl-4-bromo-, 2-methyl-5-bromo-, 2-methyl-6-bromo-, 3-bromo-4-methyl-, 3-bromo-5-methyl- or 3-methyl-4-bromophenyl, 2,4- or 2,5-dinitrophenyl, 2,5- or 3,4-dimethoxyphenyl, 2,3,4-, 2,3,5-, 2,3,6-, 2,4,6- or 3,4,5-trichlorophenyl, 2,4,6-tri-tert-butylphenyl, 2,5-dimethylphenyl, 4-iodophenyl, 4-fluoro-3-chlorophenyl, 4-fluoro-3,5-dimethylphenyl, 2-fluoro-4-bromophenyl, 2,5-difluoro-4-bromophenyl, 2,4-dichloro-5-methylphenyl, 3-bromo-6-methoxyphenyl, 3-chloro-6-methoxyphenyl, 2-methoxy-5-methylphenyl, 2,4,6-triisopropylphenyl, 1 ,3-benzodioxol-5-yl, 1 ,4-benzodioxan-6-yl, benzothiadiazol-5-yl or benzoxadiazol-5-yl or naphthyl.

Arylene has the same meanings as indicated for Ar, with the proviso that a further bond exists from the aromatic system to the closest bonding neighbour.

Specifically, the group referred to as Het can adopt the following meanings:
Het is a mono- or bicyclic saturated, unsaturated or aromatic heterocyclic radical having from 1 to 4 N, O and/or S atoms, which may be unsubstituted or mono-, di- or trisubstituted by Hal and/or A, OA, CO—AOH, COOH, COOA, COA, OH, CN, CONHA, NO₂, ═NH or ═O, where Hal is F, Cl, Br or I.
Het is preferably chromen-2-onyl, pyrrolyl, imidazolyl, pyridyl, pyrimidyl, piperidinyl, 1-methylpiperidinyl, indolyl, thiophenyl, furyl, imidazolyl, pyrazolyl, oxazolyl, isoxazolyl, thiazolyl, isothiazolyl, triazolyl, thienyl, tetrazolyl, oxadiazolyl, thiadiazolyl, thiopyranyl, pyridazinyl, pyrazyl, benzofuryl, benzothienyl, indolyl, 2,1,3-benzothiadiazolyl, benzimidazolyl, benzopyrazolyl, benzoxazolyl, benzisoxazolyl, benzothiazolyl, benzisothiazolyl, benz-2,1,3-oxadiazolyl, quinolyl, isoquinolyl or cinnolinyl, each of which is unsubstituted or mono- or disubstituted by Hal and/or A,
   where substituents can be A, OA, CO—AOH, COOH, COOA, fluorine, chlorine, bromine or iodine.
Het is particularly preferably-2- or 3-furyl, 2- or 3-thienyl, 1-, 2- or 3-pyrrolyl, 1-, 2-, 4- or 5-imidazolyl, 1-, 3-, 4- or 5-pyrazolyl, 2-, 4- or 5-oxazolyl, 3-, 4- or 5-isoxazolyl, 2-, 4- or 5-thiazolyl, 3-, 4- or 5-isothiazolyl, 2-, 3- or 4-pyridyl, 1-methylpiperidin-4-yl or piperidin-4-yl, or 2-, 4-, 5- or 6-pyrimidinyl, furthermore preferably 1,2,3-triazol-1-, -4- or -5-yl, 1,2,4-triazol-1-, -3- or 5-yl, 1- or 5-tetrazolyl, 1,2,3-oxadiazol-4- or -5-yl, 1,2,4-oxadiazol-3- or -5-yl, 1,3,4-thiadiazol-2- or -5-yl, 1,2,4-thiadiazol-3- or -5-yl, 1,2,3-thiadiazol-4- or -5-yl, 2-, 3-, 4-, 5- or 6-2H-thiopyranyl, 2-, 3- or 4-4-H-thiopyranyl, 3- or 4-pyridazinyl, pyrazinyl, 2-, 3-, 4-, 5-, 6- or 7-benzofuryl, 2-, 3-, 4-, 5-, 6- or 7-benzothienyl, 1-, 2-, 3-, 4-, 5-, 6- or 7-indolyl, 1-, 2-, 4- or 5-benzimidazolyl, 1-, 3-, 4-, 5-, 6- or 7-benzopyrazolyl, 2-, 4-, 5-, 6- or 7-benzoxazolyl, 3-, 4-, 5-, 6- or 7-benzisoxazolyl, 2-, 4-, 5-, 6- or 7-benzothiazolyl, 2-, 4-, 5-, 6- or 7-benzisothiazolyl, 4-, 5-, 6- or 7-benz-2,1,3-oxadiazolyl, 2-, 3-, 4-, 5-, 6-, 7- or 8-quinolyl, 1-, 3-, 4-, 5-, 6-, 7- or 8-isoquinolyl, 3-, 4-, 5-, 6-, 7- or 8-cinnolinyl, 2-, 4-5-, 6-, 7- or 8-quinazolinyl, 4- or 5-isoindolyl, 5- or 6-quinoxalinyl, 2-, 3-, 5-, 6-, 7- or 8-2H-benzo[1,4]oxazinyl, furthermore preferably 1,3-benzodioxol-5-yl, 1,4-benzodioxan-6-yl, 2,1 ,3-benzothiadiazol-4- or -5-yl, 2,1,3-benzoxadiazol-5-yl or chromenyl.
The heterocyclic radicals may also be partially or completely hydrogenated and adopt the following meanings:
Het is 2,3-dihydro-2-, -3-, -4- or -5-furyl, 2,5-dihydro-2-, -3-, -4- or-5-furyl, tetrahydro-2- or -3-furyl, 1,3-dioxolan-4-yl, tetrahydro-2- or -3-thienyl, 2,3-dihydro-1-, -2-, -3-, -4- or -5-pyrrolyl, 2,5-dihydro-1-, -2-, -3-, -4- or -5-pyrrolyl, 1-, 2- or 3-pyrrolidinyl, tetrahydro-1-, -2- or -4-imidazolyl, 2,3-dihydro-1-, -2-, -3-, -4- or -5-pyrazolyl, tetrahydro-1-, -3- or -4-pyrazolyl, 1,4-dihydro-1-, -2-, -3- or -4-pyridyl, 1 ,2,3,4-tetrahydro-1-, -2-, -3-, -4-, -5- or -6-pyridyl, 1-, 2-, 3- or 4-piperidinyl, 2-, 3- or 4-morpholinyl, tetrahydro-2-, -3- or -4-pyranyl, 1,4-dioxanyl, 1,3-dioxan-2-, -4- or -5-yl, hexahydro-1-, -3- or -4-pyridazinyl, hexahydro-1-, -2-, -4- or -5-pyrimidinyl, 1-, 2- or 3-piperazinyl, 1,2,3,4-tetrahydro-1-, -2-, -3-, -4-, -5-, -6-, -7- or -8-quinolyl, 1,2,3,4-tetrahydro-1-, -2-, -3-, -4-, -5-, -6-, -7- or -8-isoquinolyl, or 2-, 3-, 5-, 6-, 7- or 8-3,4-dihydro-2H-benzo[1,4]-oxazinyl, furthermore preferably 2,3-methylenedioxyphenyl, 3,4-methylenedioxyphenyl, 2,3-ethylenedioxyphenyl, 3,4-ethylenedioxyphenyl, 3,4-(difluoromethylenedioxy)phenyl, 2,3-dihydrobenzofuran-5- or -6-yl, 2,3-(2-oxomethylenedioxy)phenyl or alternatively 3,4-dihydro-2H-1,5-benzodioxepin-6- or -7-yl, furthermore preferably 2,3-dihydro-benzofuranyl or 2,3-dihydro-2-oxofuranyl.

Heterocycloalkylene or heterocycloarylene has the same meanings as indicated for Het, with the proviso that a further bond exists from the heterocyclic system to the closest bonding neighbour.

Heterocycloalkylene is preferably 1,2-, 2,3- or 1,3-pyrrolidinyl, 1,2-, 2,4-, 4,5- or 1 ,5-imidazolidinyl, 1,2-, 2,3- or 1,3-pyrazolidinyl, 2,3-, 3,4-, 4,5- or 2,5-oxazolidinyl, 1,2-, 2,3-, 3,4- or 1,4-isoxazolidinyl, 2,3-, 3,4-, 4,5- or 2,5-thiazolidinyl, 2,3-, 3,4-, 4,5- or 2,5-isothiazolidinyl, 1,2-, 2,3-, 3,4- or 1,4-piperidinyl, or 1,4- or 1,2-piperazinyl, furthermore preferably 1,2,3-tetrahydrotriazol-1,2- or -1,4-yl, 1,2,4-tetrahydrotriazol-1,2- or -3,5-yl, 1,2-.or 2,5-tetrahydrotetrazolyl, 1 ,2,3-tetrahydrooxadiazol-2,3-, -3,4-, -4,5- or -1 ,5-yl, 1,2,4-tetrahydrooxadiazol-2,3-, -3,4- or -4,5-yl, 1 ,3,4-tetrahydrothiadiazol-2,3-, -3,4-, -4,5- or -1,5-yl, 1,2,4-tetrahydrothiadiazol-2,3-, -3,4-, -4,5- or -1,5-yl, 1,2,3-thiadiazol-2,3-, -3,4-, -4,5- or -1,5-yl, 2,3- or 3,4-morpholinyl, or 2,3-, 3,4- or 2,4-thiomorpholinyl.

The hydrocarbon radical R very particularly preferably adopts meanings selected from compounds which count amongst the C₁-C₁₂-alkylene groups, C₆-C₁₄-arylene groups or C₇-C₂₀-alkylarylene groups, bonded via one or two alkyl group(s), and of these particularly preferably a C₁-C₄-alkylene chain from the series consisting of methylene, ethylene, propylene and butylene or a C₆-C₈-arylene chain from the series consisting of —C₆H₄— and —C₆H₂Me₂— or a C₇-C₉-alkylaryl chain from the series consisting of —CH₂C₆H₄—, —CH₂C₆H₂Me₂—, —CH₂C₆H₄CH₂— and —CH₂C₆H₂Me₂CH₂—.

R3 is a cyclic hydrocarbon radical which exerts a stabilising action on the compounds of the general formulae (I) and (II) compared with the prior art. H atoms in R3 may be replaced by functional groups Z.

R3 is preferably a cyclic aliphatic hydrocarbon radical A, as described above, an aromatic hydrocarbon Ar from the groups listed above or a heterocyclic substituent Het as defined above. R3 is very preferably a cyclic aliphatic or aromatic hydrocarbon radical having 6-18 carbon atoms. From this group of compounds, the radicals mesityl, triisopropylphenyl or cyclohexyl have proven particularly suitable and have resulted in particularly advantageous properties of the compounds prepared.

R1, R2 and R4, independently of one another, can be H or can adopt all meanings of Hal, A, Ar and AAr as indicated above, where H atoms in A and Ar may be replaced by functional groups Z, and Hal can be F, Cl, Br or I. Hal in R1, R2 and R4 is preferably Cl or Br. R₁, R2 and R4 are particularly preferably, independently of one another, H, Cl, Br, a straight-chain, branched, saturated or mono- or polyunsaturated C₁-C₇-alkyl radical, where one or more H in the alkyl radical may be replaced by Z.

X is an anion which is required for charge equalisation of the compounds of the general formulae (l) and (II). X is preferably singly charged. The anion X can be any desired organic or inorganic anion which is suitable for salt formation with the imidazolium compounds according to the invention. As a monovalent anion, it can be a hydroxyl, halide (Hal) from the group consisting of Br⁻, Cl⁻, I⁻ and F⁻, pseudohalide, such as cyanide(CN⁻) and thiocyanate(SCN⁻), chlorate(ClO₃⁻), perchlorate(ClO₄⁻), iodate(IO₃⁻), periodate(IO₄⁻), bromate(BrO₃⁻), perbromate(BrO₄⁻), a carboxyl anion, such as, for example, formate(CHO₂), acetate(C₂H₃O₂⁻), trifluoroacetate(CF₃CO₂⁻), propionate (C₃H₅O₂⁻), valerate(C₅H₉O₂⁻), salicylate(C₇H₅O₃⁻), gluconate(C₆H₁₁O₇⁻), citrate (C₆H₇O₇⁻) and benzoate(C₇H₅O₂⁻), carboxylate,, bicarbonate(HCO₃⁻), phenylsulfonate(C₆H₅OSO₃⁻), phenoxide(C₆H₅O⁻), methylsulfate(CH₃SO₄⁻), ethylsulfate(C₂H₅SO₄⁻), thiosulfate(S₂O₃⁻), hexafluorophosphate(PF₆⁻), hexafluoroantimonate(SbF₆⁻), tetrafluoroborate(BF₄⁻), tetrachloroborate (BCl₄⁻),(CF₃SO₂)₂N⁻, methanesulfonate(CH₃SO₃⁻), triflate[(CF₃SO₃⁻), trifluoromethanesulfonate], tosylate, nitrate(NO₃—), nitrite(NO2), ammoniumsulfate(NH₄SO₄⁻), hydrogensulfate(HSO₄⁻), borate(BO₃⁻) or a metal-containing anion(metal =Al, Sn, Sb, Cu, W, Mn, Cr, inter alia), such as, for example, tetrachloroaluminate(AlCl₄⁻), Al₂Cl₇⁻, Al₃Cl₁₀⁻, AlEtCl₃⁻, Al₂Et₂Cl₅⁻, dichlorocuprate(CuCl₂⁻), Cu₂Cl₃⁻, Cu₃Cl₄⁻, tungstate(WO₄⁻), permanganate (MnO₄⁻) or meta-antimonate(SbO₃⁻).

As already stated, functional groups Z in the radicals R1, R2, R3 and R4 may replace H atoms. These functional groups Z can carry N, P, O or S atoms and can be, inter alia, radicals having the meanings OA, NHA, NAA′, PAA′, CN, NO₂, SA, SOA, SO₂A or SO₂Ar, where A, A′ and A″, independently of one another, can adopt the meanings of A in accordance with the definition given. They can be groups which have one or more alcohol (OA), aldehyde, carboxyl, amine, amide, imide, phosphine, ether or thioether functions. A group Z preferably has the meaning OA, NHA, NAA′ or PAA′.

R1, R2 and R4 can therefore, for example, also be SO₃H, F, Cl, or a hydroxyl, alkanoyl or cycloalkanoyl radical. They can be methoxy, ethoxy, propionyl, butyryl, pentanoyl, hexanoyl, heptanoyl, octanoyl, nonanoyl, decanoyl, undecanoyl, dodecanoyl, tridecanoyl, tetradecanoyl, pentadecanoyl, hexadecanoyl, heptadecanoyl or octadecanoyl.

R1, R2 and R4 can also be acyl radicals. R1, R2 and R4 can preferably be acyl radicals having 1, 2, 3, 4, 5, 6, 7, 8, 9 or 10 carbon atoms and can be, for example, formyl, acetyl, propionyl, butyryl, trifluoroacetyl, benzoyl or naphthoyl. R1, R2 and R4 can furthermore be amino, methylamino, dimethylamino, methylthio, methylsulfinyl, methylsulfonyl or phenylsulfonyl groups.

In addition, one, two or three methylene groups in the radicals R1, R2, R3 and R4 in alkyl, alkylene, cycloalkyl, cycloalkylene, alkanoyl and cycloalkanoyl may each be replaced by N, O and/or S.

A hydrocarbon group in R1, R2 and R4 can thus adopt the meanings of A, Ar or AAr and can be an alkyl, alkenyl, aryl, alkylaryl or alkynyl group as defined above, in which one or more H atoms may be replaced by the above-mentioned functional groups Z.

The R3-substituted imidazoles required as starting materials for the preparation of the compounds of the general formula (I) can be prepared analogously to the synthetic method described in Patent Specification U.S. Pat. No. 6,177,575 analogously to the following general reaction equation:

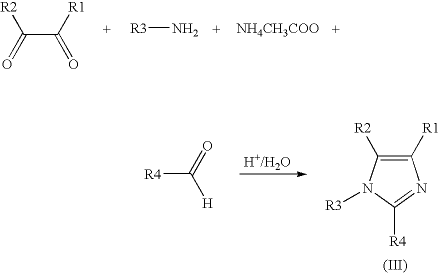

The parent structure of the compounds of the general formula (II) (R3-substituted 4,5-dihydroimidazole) can be synthesised by methods which are described in Tetrahedron Lett. 1980, 21, 885, Chem. Ber. 1965, 98, 1342 and in DE-A-11 89 998.

The performance of the substitution reaction on the imidazole ring of the general formula (III) or on the 4,5-dihydroimidazole-ring of the general formula (IV) by alkoxysilane groups of the general formula (V) is not crucial per se. The reaction can be carried out in a simple manner in plants in which all parts and devices which come into contact with the reactants are inert to the chemicals employed and exhibit no corrosion or leaching phenomena. The crucial factors are that the plant can be temperature-controlled, offers safe feed and discharge of the reactants and reaction products and has means for intensive mixing of the reaction solution. The plant should furthermore enable working under an inert-gas atmosphere and safe discharge of volatile reaction products. Accordingly, the reaction can also be carried out in a glass apparatus equipped with stirrer, feed and optionally discharge, with reflux condenser or condensation cooler with discharge, if this apparatus also offers the possibility of blanketing with inert gas. However, the reaction can also be carried out in an industrial plant which is manufactured, if appropriate, from stainless steel or other suitable inert materials and has the requisite devices for temperature control, feed and discharge of the starting materials and products.

The reaction is usually carried out in batch mode, since the substitution reaction takes place slowly in most cases.

If relatively large amounts of the desired products of the general formulae (I) and (II) are to be prepared and if the starting materials to be reacted are reactive compounds of the general formulae (III) and (IV), it may be appropriate to carry out the reaction in a corresponding plant which is designed for continuous operation.

The compounds of the general formulae (I) and (II) can be prepared by reaction of an R3-substituted imidazole of the general formula (III) or an R3-substituted 4,5-dihydroimidazole of the general formula (IV) with chlorine-, bromine- or iodine-containing alkoxysilanes Hal—R—SiR′ₙ,(OR′)₃₋ₙ without addition of a further solvent. However, it is also possible to carry out the reaction in an inert, aprotic, organic solvent.

The starting materials employed for the preparation of the compounds of the general formulae (I) and (II) are suitable R3-substituted imidazoles of the general formula (III) or R3-substituted 4,5-dihydroimidazoles of the general formula (IV).

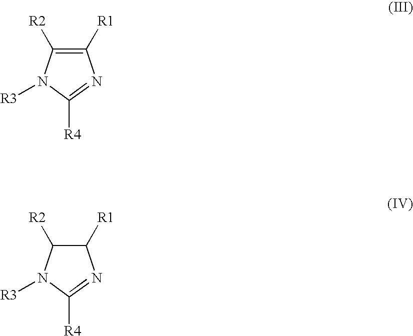

These known compounds can be prepared, as already described above, by known methods.

The products formed can be isolated in pure form as stable substances after completion of the reaction. No further by-products are formed. The halide anion present in the product for charge equalisation can be replaced by other monovalent anions by addition of metal salts MXₘ in aprotic solvents.

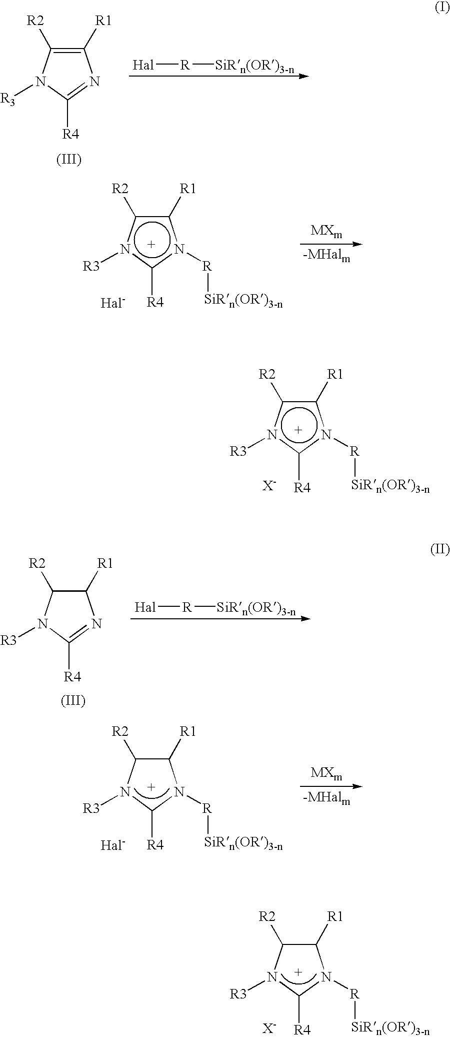

In order to carry out the substitution reaction, the starting materials can be introduced together into the reaction apparatus and heated to the reaction temperature under an inert-gas atmosphere with good mixing. The sequence of addition of the components can be selected as desired. The starting compounds can be pre-dissolved or suspended in a suitable solvent or added as a solid or liquid without a solvent.

Depending on the reactivity of the imidazole of the general formula (III) or (IV) employed, the reaction takes place within a short time or requires a number of days with maintenance of the reaction temperature. The reaction time can be from 15 minutes to 7 days. It is preferably from 30 minutes to 6 days and very preferably from 30 minutes to 5 days.

Suitable solvents which can be used for carrying out the reaction are inert, aprotic solvents.

Suitable inert solvents are, for example, hydrocarbons, such as hexane, petroleum ether, benzene, toluene or xylene; chlorinated hydrocarbons, such as-trichloroethylene, 1,2-dichloroethane, tetrachloromethane, chloroform or dichloromethane; alcohols, such as methanol, ethanol, isopropanol, n-propanol, n-butanol or tert-butanol; ethers, such as diethyl ether, diisopropyl ether, tetrahydrofuran (THF) or dioxane; glycol ethers, such as ethylene glycol monomethyl or monoethyl ether, ethylene glycol dimethyl ether (diglyme); ketones, such as acetone or butanone; amides, such as acetamide, dimethylacetamide or dimethylformamide (DMF); nitriles, such as acetonitrile; sulfoxides, such as dimethyl sulfoxide (DMSO); carbon disulfide; carboxylic acids, such as-formic acid or acetic acid; nitro compounds, such as nitromethane or nitrobenzene; esters, such as ethyl acetate, water, or mixtures of the said solvents.

Particular preference is given to the use of a solvent selected from the group consisting of hydrocarbons, chlorinated hydrocarbons and ethers.

The reaction is preferably carried out under a protective-gas atmosphere. Nitrogen or argon can be employed for this purpose.

The stoichiometric ratio of the starting materials heterocyclic compound and Hal—R—SiR′ₙ(OR′)₃₋ₙ is between 1:1 and 1:10, preferably between 1:1 and 1:3 and particularly preferably between 1:1 and 1:2.

The reaction can be carried out at a temperature in the range from 20 to +200° C., preferably from 20 to 100° C. and very preferably between 60 and 100° C. The highest yields are obtained at the boiling point of Hal—R—SiR′ₙ⁻ (OR′)₃₋ₙ.

After removal of the volatile constituents in a high vacuum, the crude product is purified by extraction or crystallisation. The compounds of the general formulae (I) and (II) can be isolated in pure form as substances and can subsequently be characterised analytically and spectroscopically.

The halide anion in the resultant compounds can be replaced by other, preferably monovalent anions with formation of the compounds of the general formulae (I) and (II) by addition of metal salts MXₘ (M=metal ion,

X=preferably monovalent anion, m corresponds to the stoichiometric valency of M, preferably 1, 2 or 3) in inert, aprotic solvents, preferably halogenated or partially halogenated hydrocarbons.

In MXₘ, M can be a metal ion selected from the group consisting of Li, Na, K, Al, Cu, Ag and Au. Preference is given to salts of the metals Li, Na, K and Al. X can adopt all the above-mentioned meanings. X is preferably methylsulfate(CH₃SO₄⁻), methanesulfonate(CH₃SO₃⁻); ethylsulfate(C₂H₅SO₄⁻), thiosulfate(S₂O₃⁻), hexafluorophosphate(PF₆⁻), tetrafluoroborate (BF₄⁻), AlCl₄⁻, (CF₃SO₂)₂N⁻, triflate [(CF₃SO₃⁻), trifluoromethanesulfonate], chlorate (ClO₃⁻), borate(BO₃⁻), tosylate, phenylsulfonate(C₆H₅OSO₃⁻), benzoate(C₇H₅O₂⁻) or ammoniumsulfate(NH₄SO₄⁻). Particular preference is given to the use of the Li, Na, K and Al salts of these anions.

Very particular preference is given to the use of the Li, Na, K and Al salts of methylsulfate(CH₃SO₄⁻), methanesulfonate(CH₃SO₃⁻), hexafluorophosphate(PF₆⁻), tetrafluoroborate(BF₄⁻), triflate[(CF₃SO₃⁻), trifluoromethanesulfonate] or borate(BO3⁻).

The by-product M-Hal formed in the case of an exchange can be separated off by filtration, or the product is separated off from the by-product by extraction.

Compounds of the general formulae (I) and (II) can, in contrast to the corresponding compounds of the prior art, be immobilised on inorganic oxides and ensure, through the sterically demanding cyclic ligands present on the nitrogen atom of the heterocyclic ring, high steric constraint of the molecule, which results in higher stability. This makes them ideal starting materials for the synthesis of stable and immobilisable NHC ligands for transition-metal catalysis. The compounds of the general formulae (I) and (II) are thermally very stable. They have higher melting and decomposition points than the immobilisable, but sterically undemanding compounds of the prior art. They are accessible in quantitative yields in a simple manner.

The compounds of the general formulae (I) and (II) serve as starting materials for the preparation of immobilised imidazolium and 4,5-dihydroimidazolium salts. The compounds of the general formulae (I) and (II) furthermore serve as starting materials for the preparation of immobilisable catalyst ligands, in particular of NHC (N-heterocyclic carbene) catalyst ligands. The compounds of the general formulae (I) and (II) can furthermore also serve as catalyst precursors and catalysts in organic synthesis. However, they can also be employed as reaction media/solvents in organic, organometallic and transition metal-catalysed reactions, such as hydrogenations, oxidations, hydroformylations, coupling reactions or oligomerisations.

Compounds of the general formulae (I) and (II) can serve as solvents in 2-phase reactions. However, they can also be used for the preparation of immobilised ionic fluids or themselves as ionic fluids.

The compounds of the general formulae (I) and (II) can be immobilised on inorganic oxides containing active OH groups on the surface. Inorganic oxides which can be used are natural or chemically prepared particulate oxides of silicon, boron, aluminium, titanium and zirconium or oxide mixtures thereof. The silicon-containing materials can be a silica gel or naturally occurring silicate derived from chain-, ribbon- and layer-form silicic acids. Preference is given to the use of the oxides of silicon and zeolites.

### 4. EXAMPLES

For better understanding and in order to illustrate the invention, examples are given below which are within the scope of protection-of the present invention. However, these are not suitable, owing to the general validity of the inventive principle described, for reducing the scope of protection of the present application merely to these examples.

### Example 1

### Synthesis of 1-mesityl-3-[3-(triethoxysilyl)propyl]imidazolium Chloride

18.63 g (0.1 mol) of 1-mesitylimidazole and 26.49. g (0.11 mol) of 3-chloropropyltriethoxysilane are introduced under an argon atmosphere into a flask fitted with reflux condenser. The mixture is refluxed at 90° C. for 5 days. The volatile constituents are removed under reduced pressure. The mixture is washed with petroleum ether until the washings remain colourless. Drying under reduced pressure gives the product as a pale-brown solid.

Melting point: 135° C. C₂₁H₃₅ClN₂O₃Si (426.21 g/mol). Analysis [%]: calculated: C 59.2, H 8.3, N 6.6; found: C 58.5,. H 7.7, N 6.8. ¹H-NMR (d₈-Thf):δ 0.64-0.72 (m, 2H, SiCH₂), 1.16 (t, ³I=7.0Hz, 9H, CH₂CH₃), 2.01-2.23 (m, 2H, NCH₂CH₂), 2.13 (s, 6H, o-C₆H₂Me₂), 2.34 (s, 3H, p-C₆H₂Me), 3.82 (q, ³I=7.0 Hz, 6H, OCH₂), 4.74 (t, ³I=7.0 Hz, 2H, NCH₂), 7.05 (s, 2H, C₆H₂Me₃), 7.66-7.70 (m, 1H, NCHCHN), 8.41-8.45 (m, 1H, NCHCHN), 11.68-11.75 (m, 1H, NCHN). ¹³C-NMR(d₈-Thf): δ 7.7 (SiCH₂), 17.9, 18.8, 21.1 (CH₂CH₃, p-C₆H₂Me, o-C₆H₂Me₂), 25.4 (NCH₂CH₂), 52.2 (NCH₂), 59.0 (OCH₂), 123.6, 124.3.(NCHCHN), 129.8 (NCN), 130.3 (aryl C_{3,5}) 132.8 (aryl C₄), 135.5 (aryl C_{2.6}), 141.3 (aryl C₁). ²⁹Si-NMR (CDCl₃): δ −47.4. FIA-ESI-MS [m/e (%)]: 391 (100) [M−Cl]⁺.

### Example 2

### Synthesis of 1-mesityl-3-[3-(triethoxysilyl)propyl]imidazolium triflate (Anion Exchange)

500 mg (1.17 mmol) of 1-mesityl-3-[3-(triethoxysilyl)propyl]imidazolium chloride and 243 mg (1.29 mmol) of potassium trifluoromethanesulfonate are dissolved in 30 ml of CH₂Cl₂ under an argon atmosphere in a flask and stirred at 25° C. for 2 hours. The resultant precipitate is separated off from the solution by filtration. The volatile constituents of the solution are removed under reduced pressure. The residue is washed a number of times with heptane and dried under reduced pressure, giving the product as a pale-brown solid.

Melting point 87° C. C₂₂H₃₅F₃N₂O₆SSi (540.19 g/mol). Analysis [%]: calculated: C 48.9, H 6.5, N 5.2; found: C 48.7, H 6.4, N 5.3. ¹H-NMR (d₈-Thf):δ 0.62-0.71 (m, 2H, SiCH₂), 1.19 (t, ³I=7.0 Hz, 9H, CH₂CH₃), 2.00-2.23 (m, 2H, NCH₂CH₂), 2.09 (s, 6H, o-C₆H₂Me₂), 2.35 (s, 3H, p-C₆H₂Me), 3.82 (q, ³I=7.0 Hz, 6H, OCH₂), 4.49 (t, ³I=7.2 Hz, 2H, NCH₂), 7.08 (s, 2H, C₆H₂Me₃), 7.60-7.64 (m, 1H, NCHCHN), 7.93-7.97 (m, 1H, NCHCHN), 9.40-9.43 (m, 1H, NCHN). ¹³C-NMR (d₈-Thf): δ 7.7 (SiCH₂), 17.3, 18.7, 21.0 (CH₂CH₃, p-C₆H₂Me, o-C₆H₂Me₂), 25.1 (NCH₂CH₂), 53.0 (NCH₂), 59.0 (OCH₂), 124.4, 124.8 (NCHCHN), 130.3 (aryl C_{3,5}), 132.4 (aryl C₄), 135.6 (aryl C_{2,6}), 138.8 (NCN), 141.6 (aryl C₁). ²⁹Si-NMR (CDCl₃): δ −47.3. FIA-ESI-MS [m/e (%)]: 391 (100) [M−Cl]⁺.

### Example 3

### Synthesis of 1-mesityl-3-[4-(trimethoxysilyl)benzyl]imidazolium Chloride

10.00 g (54 mmol) of 1-mesitylimidazole and 14.66 g (59 mmol) of (p-chloromethyl)phenyltrimethoxysilane are introduced under an argon atmosphere into a nitrogen flask and boiled overnight at 80° C. A dark-brown solution is formed, which becomes a solid after about 30 minutes. This is dissolved in CH₂CI₂, and the solution is evaporated under reduced pressure until a dark-brown, viscous substance remains. This is washed a number of times with heptane and dried under reduced pressure, giving the product as a pale-brown powder.

Melting point: 170° C. C₂₂H₂₉ClN₂O₃Si (433.03 g/mol). Analysis [%] calculated: C 61.0, H 6.8, N 6.5, found: C 58.7, H 7.1, N 5.8. ¹H-NMR (CDCl₃): δ 1.96 (s, 6H, o-C₆H₂Me₂), 2.24 (s, 3H, p-C₆H₂Me), 3.54 (s, 9H, OMe₃), 5.90 (s, 2H, CH₂), 6.89 (s, 2H, C₆H₂Me₃) 7.10 (m, 1H, NCHCHN), 7.54 (d, I³=0.03 Hz, 2H, C₆H₄), 7.60 (d, I³=0.03 Hz, 2H, C₆H₄), 7.69 (m, 1H, NCHCHN), 10.82 (s, 1H, NCHN). ¹³C-NMR (CDCl₃): δ 18.2 (o-C₆H₂Me₂), 21.7 (p-C₆H₂Me), 51.5 (OMe₃), 53.9 (CH₂), 123.4, 123.9 (NCHCHN), 129.1 (benzyl C_{3,5}), 130.4 (aryl C_{3,5}), 136.4 (benzyl C_{2,6}), 139.3 (NCN), the quaternary carbon atoms could not be detected unambiguously. ²⁹Si-NMR: δ 55.5. FIA-ESI-MS [m/e (%)]: 397 (100) [M−Cl]⁺.

### Example 4

### Synthesis of 1-mesityl-3-[4-(trimethoxysilyl)benzyl]imidazolium triflate

3 g (6.93 mol) of 1-mesityl-3-[4-(trimethoxysilyl)benzyl]imidazolium chloride, 1.43 g (7.62 mol) of potassium triflate (potassium trifluoromethanesulfonate) and 50 ml of CH₂CI₂ are introduced into a nitrogen flask. The mixture is stirred at room temperature for 3 hours. The resultant precipitate is separated off from the solution by filtration. The volatile constituents of the solution are removed under reduced pressure. The residue is washed a number of times with diethyl ether and dried under reduced pressure, giving the product as a brown powder.

Melting point: 102° C. C₂₃H₂₉F₃N₂O₆SSi (546.14 g/mol). Analysis [%] calculated: C 50.5, H 5.3, N 5.1, found: C 50.0, H 5.1, N 4.9. ¹H-NMR (CDCl₃): δ 1.99 (s, 6H, o-C₆H₂Me₂), 2.31 (s, 3H, p-C₆H₂Me), 3.61 (s, 9H, OMe₃), 5.60 (s, 2H, CH₂), 6.97 (s, 2H, C₆H₂Me₃) 7.15-7.16 (m, 1H, NCHCHN), 7.47 (d, I³=8.1 Hz, 2H, C₆H₄), 7.55-7.56 (m, 1H, NCHCHN), 7.68 (d, I³=8.1 Hz, 2H, C₆H₄), 9.21 (s, 1H, NCHN). ¹³C-NMR (CDCl₃): δ 17.2 (o-C₆H₂Me₂), 21.0 (p-C₆H₂Me), 50.9 (OMe₃), 53.5 (CH₂), 123.1, 123.7 (NCHCHN), 128.3 (benzyl C_{3,5}), 129.8.(aryl C_{3,5}),135.9 (benzyl C_{2,6}), 137.1 (NCN), the quaternary carbon atoms could not be detected unambiguously. ²⁹Si-NMR: δ 55.7. FIA-ESI-MS [m/e (%)]: 397 (100) [M−Cl]⁺.

1. Compounds of the general formulae (I) and (II) 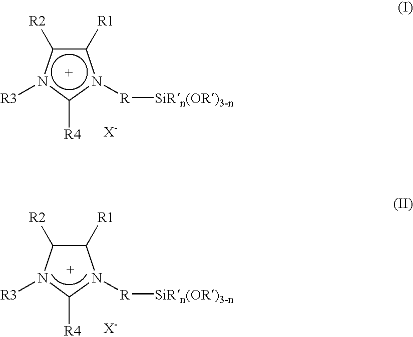
in which
R is A, Ar, A—Ar, A—Ar—A, Het, AHet or AHetA having a total of not more than 30 carbon atoms, where
A is a straight-chain, branched, saturated or mono- or polyunsaturated C₁-C₂₀-alkyl radical, cycloalkyl or cycloalkyl bonded via one or two alkyl group(s) having a total of 4-30 carbon atoms, where one CH₂ or CH group both in the alkyl radical and in the cycloalkyl radical may be replaced by N, NH, NA, O and/or S,
Ar is mono- or polysubstituted or unsubstituted phenyl, naphthyl, anthryl or phenanthryl having a total of not more than 20 carbon atoms, where substituents may be A, Hal, OA, CO—AOH, COOH, COOA, COA, OH, CN, CONHA, NO₂, ═NH or ═O,
Het is a monocyclic or bicyclic, saturated, unsaturated or aromatic heterocyclic radical having from 1 to 4 N, O and/or S atoms, which may be unsubstituted or mono-, di- or trisubstituted by Hal and/or A, OA, CO—AOH, COOH, COOA, COA, OH, CN, CONHA, NO₂, ═NH or ═O, where
Hal is F, Cl, Br or I,
R′, independently of the position in the molecule, is A or Ar having 1-12 carbon atoms,
R3 is A, Ar, AAr, AArA, Het, AHet or AHetA having 6-18 carbon atoms, in which the radical A which is not bonded to Ar or Het is cycloalkyl which is unsubstituted or substituted by one or more groups Z, and Ar is an aromatic hydrocarbon which is unsubstituted or mono- or polysubstituted by a group Z, and Het is a saturated, unsaturated or aromatic heterocyclic radical, which may be mono- or polysubstituted by a group Z, and
R1, R2 and R4, independently of one another, are H, Cl, Br or a straight-chain, branched, saturated or mono- or polyunsaturated C₁-C₇-alkyl radical, where one or more H in the alkyl radical may be replaced by Z,
X is a singly charged organic or inorganic salt-forming anion,
Z is A or Ar, where H atoms in A or Ar may be substituted, independently of the position in R1, R2, R3 and R4, by functional groups containing N, P or O atoms, and
n is 0, 1 or 2.

2. Compounds according to claim 1 of the general formulae (I) and (II), in which
R is A, Ar, A—Ar, A—Ar—A, Het, AHet or AHetA having a total of not more than 30 carbon atoms,
R′, independently of the position in the molecule, is a straight-chain, branched, saturated or mono- or polyunsaturated C₁-C₇-alkyl radical,
R3 is A, Ar, AAr, MrA, Het, AHet or AHetA having 6-18 carbon atoms, in which the radical A which is not bonded to Ar or Het is cycloalkyl which is unsubstituted or substituted by one or more groups Z, and
Ar is an aromatic hydrocarbon which is unsubstituted or mono- or polysubstituted by a group Z,
and Het is a saturated, unsaturated or aromatic heterocyclic radical, which may be mono- or polysubstituted by a group Z, and
R1, R2 and R4, independently of one another, are H, Cl, Br or a straight-chain, branched, saturated or mono- or polyunsaturated C₁-C₇-alkyl radical,
X is a singly charged organic or inorganic salt-forming anion,
Z is A, and
n is 0,
and A, Ar and Het are as defined in claim 1.

3. Compounds according to claim 1 of the general formulae (I) and (II), in which
R is A, Ar, A—Ar or A—Ar—A having a total of not more than 20 carbon atoms, where
A is a straight-chain or branched, saturated C₁-C₁₀-alkyl radical, cycloalkyl having 3-10 carbon atoms or C₄-C₂₀-cycloalkyl which is bonded via one or two alkyl group(s),
Ar is mono- or polysubstituted or unsubstituted phenyl, where substituents can adopt the meanings of A, and R has a total of not more than 20 carbon atoms,
R′, independently of the position in the molecule, is a straight-chain, branched, saturated C₁-C₇-alkyl radical,
R3 is A with the meaning of cycloalkyl which is unsubstituted or substituted by one or more groups Z,
or Ar is an aromatic hydrocarbon which is unsubstituted or substituted by Z=A,
R1, R2 and R4, independently of one another, are H or a straight-chain, branched, saturated C₁-C₇-alkyl radical,
X is a singly charged organic or inorganic salt-forming anion,
Z is A, and
n is 0,
and A and Ar are as defined in claim 1.

4. Compounds according to claim 1 of the general formulae (I) and (II), in which
R′, independently of the position in the molecule, is methyl, ethyl, propyl, isopropyl, butyl, isobutyl, sec- or tert-butyl, pentyl, 1-, 2- or 3-methylbutyl(—C₅H₁₀—), 1,1-, 1,2- or 2,2-dimethylpropyl (—C₅H₁₀—), 1-ethylpropyl(—C₅H₁₀—), hexyl(—C₆H₁₂—), 1-, 2-, 3- or 4-methylpentyl(—C₆H₁₂—), 1,1-, 1,2-, 1,3-, 2,2-, 2,3- or 3,3-dimethylbutyl(—C₆H₁₂—), 1- or 2-ethylbutyl(—C₆H₁₂—), 1-ethyl-1-methylpropyl(—C₆H₁₂—), 1-ethyl-2-methylpropyl(—C₆H₁₂—), 1,1,2- or 1 ,2,2-trimethylpropyl(—C₆H₁₂—), heptyl or octyl.

5. Compounds according to claim 1 of the general formulae (I) and (II), in which
R is A, Ar or A—Ar, where
A is a straight-chain, saturated C₁-C₁₀-alkyl radical or C₃-C₆-cycloalkyl, and
Ar is phenyl, unsubstituted or mono- or polysubstituted by Z=A,
R′, independently of the position in the molecule, is a straight-chain or branched, saturated-C₁-C₄-alkyl radical,
R3 is A with the meaning of cycloalkyl, or Ar an aromatic hydrocarbon which is unsubstituted or mono- or polysubstituted by Z=A,
R1, R2 and R4 are H,
X is a singly charged organic or inorganic salt-forming anion, and
n is 0,
and A and Ar are as defined in claim 1.

6. Compounds according to claim 1 of the general formulae (I) and (II), in which
R is methyl, ethyl, propyl, isopropyl, butyl, isobutyl, sec- or tert-butyl, 1,2-cyclopropyl, 1,2- or 1,3-cyclobutyl, 1,2- or 1,3-cyclopentyl, 1,2-, 1,3- or 1,4-cyclohexyl, furthermore 1,2-, 1,3- or 1,4-cycloheptyl, methylcyclopentyl, methylcyclohexyl, phenyl, benzyl(—CH₂C₆H₄—), tolyl(—C₆H₃(CH₃)—), —C₆H₂(CH₃)₂—, —CH₂C₆H₂(CH₃)₂—, —CH₂C₆H₄CH₂—, —CH₂C₆H₂(CH₃)₂CH₂—, trimethylphenyl or naphthyl,
R′is methyl, ethyl, propyl, isopropyl, butyl, isobutyl, sec- or tert-butyl,
R3 is cyclopropyl, cyclobutyl, cyclopentyl, cyclohexyl, methylcyclopentyl, cycloheptyl, methylcyclohexyl, cyclooctyl, furanyl, phenyl, benzyl, tolyl, trimethylphenyl, 2,4,6-methylphenyl(mesityl) , triisopropylphenyl or naphthyl,
R1, R2 and R4 are H, methyl or ethyl,
X is Cl, Br, PF₆⁻, BF₄⁻, trifluoromethanesulfonate, methanesulfonate, methylsulfate, ethylsulfate, tosylate, thiosulfate, chlorate(ClO₃⁻), borate⁻(BO₃⁻), phenylsulfonate(C₆H₅OSO₃⁻), benzoate(C₇H₅O₂⁻) or ammoniumsulfate(NH₄SO₄⁻),
n is 0.

7. 1-mesityl-3-[3-(triethoxysilyl)propyl]imidazolium chloride
1-mesityl-3-[3-(triethoxysilyl)propyl]imidazolium bromide
1-mesityl-3-[3-(triethoxysilyl)propyl]imidazolium triflate
1-mesityl-3-[3-(triethoxysilyl)propyl]imidazolium tetrafluoroborate
1-mesityl-3-[3-(triethoxysilyl)propyl]imidazolium hexafluorophosphate
1-mesityl-3-[3-(trimethoxysilyl)propyl]imidazolium chloride
1-mesityl-3-[3-(trimethoxysilyl)propyl]imidazolium bromide
1-mesityl-3-[3-(trimethoxysilyl)propyl]imidazolium triflate
1-mesityl-3-[3-(trimethoxysilyl)propyl]imidazolium tetrafluoroborate
1-mesityl-3-[3-(trimethoxysilyl)propyl]imidazolium hexafluorophosphate
1-mesityl-3-[4-(trimethoxysilyl)benzyl]imidazolium chloride
1-mesityl-3-[4-(trimethoxysilyl)benzyl]imidazolium bromide
1-mesityl-3-[4-(trimethoxysilyl)benzyl]imidazolium triflate
1-mesityl-3-[4-(trimethoxysilyl)benzyl]imidazolium tetrafluoroborate
1-mesityl-3-[4-(trimethoxysilyl)benzyl]imidazolium hexafluorophosphate
1-mesityl-3-[4-(triethoxysilyl)benzyl]imidazolium chloride
1-mesityl-3-[4-(triethoxysilyl)benzyl]imidazolium bromide
1-mesityl-3-[4-(triethoxysilyl)benzyl]imidazolium triflate
1-mesityl-3-[4-(triethoxysilyl)benzyl]imidazolium tetrafluoroborate
1-mesityl-3-[4-(triethoxysilyl)benzyl]imidazolium hexafluorophosphate
1-mesityl-3-[3-(triethoxysilyl)propyl]imidazolium chloride
1-mesityl-3-[3-(triethoxysilyl)propyl]imidazolium bromide
1-mesityl-3-[3-(triethoxysilyl)propyl]imidazolium triflate
1-mesityl-3-[3-(triethoxysilyl)propyl]imidazolium tetrafluoroborate
1-mesityl-3-[3-(triethoxysilyl)propyl]imidazolium hexafluorophosphate
1-cyclohexyl-3-[3-(trimethoxysilyl)propyl]imidazolium chloride
1-cyclohexyl-3-[3-(trimethoxysilyl)propyl]imidazolium bromide
1-cyclohexyl-3-[3-(trimethoxysilyl)propyl]imidazolium triflate
1-cyclohexyl-3-[3-(trimethoxysilyl)propyl]imidazolium tetrafluoroborate
1-cyclohexyl-3-[3-(trimethoxysilyl)propyl]imidazolium hexafluorophosphate
1-cyclohexyl-3-[4-(trimethoxysilyl)benzyl]imidazolium chloride
1-cyclohexyl-3-[4-(trimethoxysilyl)benzyl]imidazolium bromide
1-cyclohexyl-3-[4-(trimethoxysilyl)benzyl]imidazolium triflate
1-cyclohexyl-3-[4-(trimethoxysilyl)benzyl]imidazolium tetrafluoroborate
1-cyclohexyl-3-[4-(trimethoxysilyl)benzyl]imidazolium hexafluorophosphate
1-cyclohexyl-3-[4-(triethoxysilyl)benzyl]imidazolium chloride
1-cyclohexyl-3-[4-(triethoxysilyl)benzyl]imidazolium bromide
1-cyclohexyl-3-[4-(triethoxysilyl)benzyl]imidazolium triflate
1-cyclohexyl-3-[4-(triethoxysilyl)benzyl]imidazolium tetrafluoroborate
1-cyclohexyl-3-[4-(triethoxysilyl)benzyl]imidazolium hexafluorophosphate
1-mesityl-3-[3-(triethoxysilyl)propyl]-4,5-dihydroimidazolium chloride
1-mesityl-3-[3-(triethoxysilyl)propyl]-4,5-dihydroimidazolium bromide
1-mesityl-3-[3-(triethoxysilyl)propyl]-4,5-dihydroimidazolium triflate
1-mesityl-3-[3-(triethoxysilyl)propyl]-4,5-dihydroimidazolium tetrafluoroborate
1-mesityl-3-[3-(triethoxysilyl)propyl]-4,5-dihydroimidazolium hexafluorophosphate
1-mesityl-3-[3-(trimethoxysilyl)propyl]-4,5-dihydroimidazolium chloride
1-mesityl-3-[3-(trimethoxysilyl)propyl]-4,5-dihydroimidazolium bromide
1-mesityl-3-[3-(trimethoxysilyl)propyl]-4,5-dihydroimidazolium triflate
1-mesityl-3-[3-(trimethoxysilyl)propyl]-4,5-dihydroimidazolium tetrafluoroborate
1-mesityl-3-[3-(trimethoxysilyl)propyl]-4,5-dihydroimidazolium hexafluorophosphate
1-mesityl-3-[4-(trimethoxysilyl)benzyl]-4 ,5-dihydroimidazolium chloride
1-mesityl-3-[4-(trimethoxysilyl)benzyl]-4,5-dihydroimidazolium bromide
1-mesityl-3-[4-(trimethoxysilyl)benzyl]-4,5-dihydroimidazolium triflate
1-mesityl-3-[4-(trimethoxysilyl)benzyl]-4,5-dihydroimidazolium tetrafluoroborate
1-mesityl-3-[4-(trimethoxysilyl)benzyl]-4,5-dihydroimidazolium hexafluorophosphate
1-mesityl-3-[4-(triethoxysilyl)benzyl]-4,5-dihydroimidazolium chloride
1-mesityl-3-[4-(triethoxysilyl)benzyl]-4,5-dihydroimidazolium bromide
1-mesityl-3-[4-(triethoxysilyl)benzyl]-4,5-dihydroimidazolium triflate
1-mesityl-3-[4-(triethoxysilyl)benzyl]4,5-dihydroimidazolium tetrafluoroborate 1-mesityl-3-[4-(triethoxysilyl)benzyl]-4,5-dihydroimidazolium hexafluorophosphate
1-mesityl-3-[3-(triethoxysilyl)propyl]-4,5-dihydroimidazolium chloride
1-mesityl-3-[3-(triethoxysilyl)propyl]-4,5-dihydroimidazolium bromide
1-mesityl-3-[3-(triethoxysilyl)propyl]-4,5-dihydroimidazolium triflate
1-mesityl-3-[3-(triethoxysilyl)propyl]-4,5-dihydroimidazolium tetrafluoroborate
1-mesityl-3-[3(triethoxysilyl)propyl]-4,5-dihydroimidazolium hexafluorophosphate
1-cyclohexyl-3-[3-(trimethoxysilyl)propyl]-4,5-dihydroimidazolium chloride
1-cyclohexyl-3-[3-(trimethoxysilyl)propyl]-4,5-dihydroimidazolium bromide
1-cyclohexyl-3-[3-(trimethoxysilyl)propyl]-4,5-dihydroimidazolium triflate
1-cyclohexyl-3-[3-(trimethoxysilyl)propyl]-4,5-dihydroimidazolium tetrafluoroborate
1-cyclohexyl-3-[3-(trimethoxysilyl)propyl]-4,5-dihydroimidazolium hexafluorophosphate
1-cyclohexyl-3-[4-(trimethoxysilyl)benzyl]-4,5-dihydroimidazolium chloride
1-cyclohexyl-3-[4-(trimethoxysilyl)benzyl]-4,5-dihydroimidazolium bromide
1-cyclohexyl-3-[4-(trimethoxysilyl)benzyl]-4,5-dihydroimidazolium triflate
1-cyclohexyl-3-[4-(trimethoxysilyl)benzyl]-4,5-dihydroimidazolium tetrafluoroborate
1-cyclohexyl-3-[4-(trimethoxysilyl)benzyl]-4,5-dihydroimidazolium hexafluorophosphate
1-cyclohexyl-3-[4-(triethoxysilyl)benzyl]-4,5-dihydroimidazolium chloride
1-cyclohexyl-3-[4-(triethoxysilyl)benzyl]-4,5-dihydroimidazolium bromide
1-cyclohexyl-3-[4-(triethoxysilyl)benzyl]-4,5-dihydroimidazolium triflate
1-cyclohexyl-3-[4-(triethoxysilyl)benzyl]-4,5-dihydroimidazolium tetrafluoroborate
1-cyclohexyl-3-[4-(triethoxysilyl)benzyl]-4,5-dihydroimidazolium hexafluorophosphate
as compounds according to claim 1.

8. Process for the preparation of compounds of the general formulae (I) and (II), characterised in that
an R3-substituted imidazole of the general formula (III) 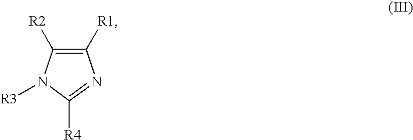
or an R3-substituted 4,5-dihydroimidazole of the general formula (IV) 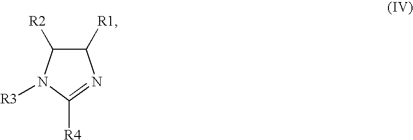
in which R1, R2, R3 and R4 are as defined in claim 1, is reacted with a chlorine-, bromine- or iodine-containing alkoxysilane of the general formula (V)
Hal—R—SiR′ₙ(OR′)₃₋ₙ, (V)
in which
Hal is Cl, Br or I, and
R and R′ are as defined in claim 1,
optionally in an inert, aprotic, organic solvent,
the reaction product is isolated, and the halide anion is optionally replaced by another monovalent anion by addition of a metal salt of the general formula (VI)
MXₘ, (VI)
in which
M is Li, Na, K, Al, Cu, Ag or Au,
X is a singly charged anion from the group consisting of cyanide, thiocyanate, chlorate, perchlorate, iodate, periodate, bromate, perbromate, BF₄⁻, PF₆⁻, AlCl₄⁻, formate, acetate, propionate, valerate, salicylate, gluconate, citrate, benzoate, carboxylate, bicarbonate, phenylsulfonate, phenoxide, methylsulfate, ethylsulfate, thiosulfate, phosphorhexafluoride, boron tetrafluoride, (CF₃SO₂)₂N⁻, methylsulfate, methanesulfonate, triflafe(trifluoromethanesulfonate), tosylate, nitrate, nitrite, ammonium sulfate, hydrogen sulfate, borate and the group of metal-containing anions, and
m is 1, 2 or 3,
in an aprotic solvent selected from the group consisting of halogen-containing hydrocarbons, acyclic and cyclic ethers, aromatic and aliphatic hydrocarbons, nitrites and esters.

9. Process according to claim 8, characterised in that the reaction is carried out under a protective-gas atmosphere.

10. Process according to claim 8, characterised in that the reaction is carried out under nitrogen or argon as protective-gas atmosphere.

11. Process according to claim 8, characterised in that, in order to carry out the reaction, the stoichiometric ratio of the starting materials heterocyclic compound and Hal—R—SiR′ₙ(OR′)₃₋ₙ is set in a range between 1:1 and 1:10.

12. Process according to claim 8, characterised in that the reaction is carried out at a temperature in the range between 20 and +200° C., preferably from 20 to 100° C. and very preferably between 60 and 100° C.

13. Use of compounds of the general formulae (I) and (II) as starting material for the preparation of immobilised imidazolium and 4,5-dihydroimidazolium salts.

14. Use of compounds of the general formulae (I) and (II) as starting materials for the preparation of immobilisable catalyst ligands, immobilisable catalyst precursors, immobilisable catalysts or immobilisable N-heterocyclic carbene ligands.

15. Use of compounds of the general formulae (I) and (II) as catalysts in organic or organometallic and transition metal-catalysed reactions.

16. Use of compounds of the general formulae (I) and (II) as reaction media or as solvents in organic or organometallic and transition metal-catalysed reactions, such as hydrogenations, oxidations, hydroformylations, coupling reactions or oligomerisations.

17. Use of compounds of the general formulae(I) and (II) as solvents in 2-phase reactions.

18. Use of compounds of the general formulae (I) and (II) as starting materials for the preparation of immobilised ionic fluids.

19. Use of compounds of the general formulae (I) and (II) as ionic fluids.

20. Use of compounds of the general formulae (I) and (II) as starting materials for immobilised reaction media.

21. Use of compounds of the general formulae (I) and (II) as separation media for the separation of substance mixtures and as medium for the purification of reaction products (scavenger function).
